(19) United States
(12) Patent Application Publication
(10) Pub. No.: US 2026/0286728 A1
(43) Pub. Date: Sep. 24, 2026

(54) ARTICLE FOR USE IN INDUSTRIAL FACILITIES

(71) Applicant: ROSS, Dublin (IE)

(72) Inventors: Fergus NAUGHTON, Ballygar (IE); John O'DRISCOLL, Lucan (IE); Michael HOPKINS, Jr., Althone (IE)

(73) Assignee: ROSS, Dublin (IE)

(21) Appl. No.: 19/477,070

(22) PCT Filed: Apr. 20, 2024
(86) PCT No.: PCT/EP2024/060851

§ 371 Date: Oct. 20, 2025

(30) Foreign Application Priority Data
Apr. 21, 2023 (GB) 2305881.1

(51) Int. Cl. E04G 15/06

(52) U.S. Cl. CPC E04G 15/061

(57) ABSTRACT

An article or penetration opening sealing cover (1) for use in an area or facility requiring a highly controlled environment, the article or penetration opening sealing cover (1) comprising an upstand (2) having a first side (3) and a second side (4); an outer wall (5) and an inner wall (6) connecting the first side (3) and the second side (4), wherein the inner wall (6) defines a central cavity (7); and an outer lip (8) comprising a top side (9) and a bottom side (10), wherein the article or penetration opening sealing cover (1) is adapted to slot into, and seal, an opening in a floor of the facility or area.

### FIELD OF THE INVENTION

The invention relates to an article or penetration opening sealing cover that acts as an multifunctional insert for an opening in a floor, wall or ceiling of a building or facility. Specifically, the invention relates to removable article that acts as a floor covering in cleanroom facilities, data centres, and areas which require highly controlled environmental conditions.

### BACKGROUND TO THE INVENTION

Cleanroom environments are typically enclosed environments located within a larger building, for example, a foundry in a semiconductor facility, that have tight control over temperature, humidity, airflow, temperature change over time, noise, vibration, lighting, and airborne particles. Facilities must regulate there parameters to maintain the highest quality air standards, while optimising productivity, maintaining all elements of safety and fire restriction performance.

Cut-out portions in the floors of a cleanroom are required to facilitate the provision of utilities. The current method of stopping goods from falling through the cut-out portions using a loose high-density polyethylene (HDPE) net, which is considerably flawed in terms of its functionality. The issues with the HDPE net are that it is weak, difficult to repair once cut to install a service, once cut its protective and strength function is compromised. Videos are available of drop tests carried out on this mesh section and clearly shows its advantages over other methods.

Problems with the current plan on record (POR) methods of controlling spills, managing safety and sealing popout openings in facilities are as follows:
Traditional methods have to be carried out through three to four different steps utilising various different venders which is quite time consuming and expensive.
The current method of stopping objects falling through the floor cut-out openings utilise a light netting, however during the install of services, the netting is cut by the various trades people and are not repairable, and thus have to be replaced.
Current methods of spill control are created from plastic/aluminium individual lengths of right angle profiles. These are individually placed around the floor opening and sealed into position. The problem here is that due to the individual assembly, there are lots of joints that requiring sealing, which leaves the individual lengths of plastic/aluminium lacking in structural integrity and vulnerable to breakage during services installation.
Current methods for creating the sealed cut-out opening utilises a range of products such as HDPE foam and a two-part resin (for example, Penatron® by ASTC Polymers), which requires specialised equipment to mix and to install. One of the main problems with this method is its cost, long length of time to install, the time required for the resin to cure (min 24 hrs), and the toxic nature of the resin, which is reported to be carcinogenic and correct respiratory equipment must be used when working with it.
Services penetrating current floor cut outs have no method of attachment in the cut out areas which leads to difficulty fitting services in these areas.
For wet cover applications, if services need to be moved or replaced after initial installation, the POR method has to be completely removed.

U.S. Pat. No. 10,256,617 describes an underground enclosure or assembly configured to protect wiring connections and provide access to those connections for initial installation, and later for maintenance or alteration. The handhole assembly includes a body with a generally cylindrical shape. U.S. Pat. No. 8,507,798 describes an improved form of sealing grommet incorporating an impermeable, flexible elastomeric sealing member providing highly efficient sealing under all operating conditions. U.S. Pat. No. 8,178,795 describes an apparatus designed for retrofitting cable management systems and repairing or replacing outdated cable management apparatus used in building platform technology where an access floor system is used to deliver a source of building air, such as HVAC, or simply the passage of the cables through a raised flooring structure. U.S. Pat. No. 4,054,222 describes a circular support member for covering electrical floor boxes.

It is an object of the present invention to overcome at least one of the above-mentioned problems.

### SUMMARY OF THE INVENTION

The claimed invention relates to an article or penetration opening sealing cover that acts as a catchment mesh with or without spill control features in spaces in facilities that require a highly controlled environment. The use of the claimed invention provides a significant safety feature preventing objects falling through a penetration opening in the floor or through a wall of the environmentally controlled space onto the floor below or adjacent room, or outside the building, which will have people working and walking around in. The article or penetration opening sealing cover is designed to fit into floor, wall or ceiling openings of any shape or size, and is kept in place by an appropriate sealant and/or adhesive. Facilities where the claimed article or penetration opening sealing cover can be used are, for example, semi-conductor cleanroom facilities, data centres, hospital theatres, or any areas that require highly controlled environmental conditions. The claimed article or penetration opening sealing cover incorporates several features which traditionally had to be carried out through three to four different steps utilising various different expert installation vendors. The functional and design aspects of the claimed article or penetration opening sealing cover is a superior alternative to the current POR designs used in the field for current covers, and uses a range of semi crystalline engineering polymeric materials such as polypropylene (PP), polyethylene (PE), and polyvinylidene fluoride (PVDF), and polyphenylene sulfide (PPS), are suitable for use in highly regulated cleanroom environments.

There is provided, as set out in the appended claims, a penetration opening sealing cover or article (1), the penetration opening sealing cover or article (1) comprising a body member or an upstand (2) having a first side (3) and a second side (4); an outer wall (5) and an inner wall (6) connecting the first side (3) and the second side (4), wherein the inner wall (6) defines a central cavity (7); and an outer lip (8) comprising a top side (9) and a bottom side (10), wherein the body member or the upstand (2) is configured to prevent a spillage from passing through the penetration opening sealing cover or article (1).

In one aspect, there is provided a penetration opening sealing cover (1) comprising an upstand (2) having a first side (3) and a second side (4); an outer wall (5) and an inner wall (6) connecting the first side (3) and the second side (4), wherein the inner wall (6) defines a central cavity (7); and an outer lip (8) comprising a top side (9) and a bottom side (10), wherein the upstand (2) is configured to prevent a spillage from passing through the penetration opening sealing cover (1), and wherein the first side (3) further comprises a lattice structure (12) that spans the width of the central cavity (7).

The penetration opening sealing cover or article (1) is adapted to slot into, and seal, an opening in a floor of the area.

In one aspect, the outer lip (8) is attached to, and follows the perimeter of, the outer wall (5) of the body member or the upstand (2).

In one aspect, the outer lip (8) is located between the first side (3) and the second side (4) of the penetration opening sealing cover or article (1), and further comprises at least one buttress (11) attached to the top side (9) of the outer lip (8) and the outer wall (5) of the body member or the upstand (2).

In one aspect, the outer lip (8) is situated at the first side (3) and forms a lip around the perimeter of the penetration opening sealing cover or article (1).

In one aspect, the central cavity (7) is open from the second side (4) and through the first side (3).

In one aspect, the first side (4) is closed.

In one aspect, the first side (3) further comprises a lattice structure (12) that spans the width of the central cavity (7). Preferably, the lattice structure (12) comprises a regular series of strips of polymer crossed and fastened together with shaped spaces left between. In one aspect, the series of strips of polymer of the lattice structure each have a thickness of between about 2 mm and about 12 mm.

In one aspect, the penetration opening sealing cover or article (1) further comprises an insert (20). In one aspect, the insert (20) comprises a top surface (21) having a lattice structure (22), and a wall (24) extending from the top surface (21). Preferably, the wall (24) comprises an external surface (23) and an internal surface (26). In one aspect, the internal surface (26) of the wall (24) creates a space (28) within which is located a series of (30) attached to, and extending inward from, the internal surface (26) of the wall (24) such that they converge towards one another.

In one aspect, the insert (20) is configured to fit within the dimensions of the bore (7) of the penetration opening sealing cover or article (1).

In one aspect, the penetration opening sealing cover or article (1) further comprises a sub-assembly (40), the sub-assembly (40) comprising a support structure (42) adapted to moveably support a strut channel (44). In one aspect, the strut channel (44) comprises a pair of moveable struts (46a, b) that traverse the diameter of the bore (7) and which move in opposite directions to each other along the inner wall (6) of the body member or the upstand (2).

In one aspect, the sub-assembly (40) is configured to sit in the bore (7) of the penetration opening sealing cover or article (1)

In one aspect, the sub-assembly (40) is composed of a metal selected from mild steel, plain carbon steel, galvanised steel, stainless steel, or a zinc dichromate coating thereof.

In one aspect, the penetration opening sealing cover or article (1) is composed of a polymer selected from polypropylene, polyethylene, polytetrafluoroethylene, nylon, polyester, or a combination thereof.

In one aspect, the penetration opening sealing cover or article (1) is comprised of a single piece.

### Definitions

In the specification, the term “industrial facility” should be understood to mean a building that is not used for domestic use, for example, flexible workspaces with room for various applications (office space, research and development (R&D), data centres and the like); heavy industrial buildings (manufacturing buildings that include extensive high-capacity HVAC and ventilation systems, pressurised air and water lines, floor drains, etc.); light manufacturing buildings; R&D buildings; refrigeration buildings; telecom centres; warehouse and distribution buildings; wet lab buildings (biotech buildings featuring high-tech labs); semiconductor manufacturing foundries and information technology buildings.

In the specification, the term “cleanroom” should be understood to mean a room within which the number concentration of airborne particles is controlled and classified, and which is designed, constructed and operated in a manner to control the introduction, generation and retention of particles inside the room. The room, typically used in technical manufacturing, scientific research or surgical procedures, has a low level of environmental pollutants such as dust, airborne microbes, aerosol particles and chemical vapours.

In the specification, the term “strut channel” should be understood to mean a strut channel that is a standardized formed structural system used in the construction and electrical industries for light structural support, often for supporting wiring, plumbing, or mechanical components such as air conditioning or ventilation systems.

In the specification, the term “article” or “penetration opening sealing cover” are interchangeable and should be understood to mean a cover that seals an opening in a floor, wall, or ceiling of an industrial facility. The penetration opening sealing cover prevents liquid spills from passing the though the opening in the floor, wall or ceiling; and also permits the attachment of services allowing them to pass through the opening.

In the specification, the term “low carbon steel” should be understood to mean steel containing roughly between 0.05% and 0.25% of carbon by weight, while the term “high carbon steel” should be understood to mean steel that can be composed of up to 2.5% carbon by weight.

In the specification the term “polymer” should be understood to mean any polypropylene (PP), polyethylene (PE), polyvinylidene fluoride (PVDF), nylon (Pa), polyester (PET), polytetrafluoroethylene (PTFE), polyphenylene sulfide (PPS) or a blend thereof. The polymers used should have high levels of chemical resistance, flame retardancy and no volatile organic compounds (VOCs).

In the specification, the term “polymer blend” should be understood to mean a mixture of two or more polymers and other additives in the manufacture of an article, such as the penetration opening sealing cover of the claimed invention. One example of a polymer blend that can be used in manufacturing the penetration opening sealing cover or article of the claimed invention comprises one or more of:
Polymer: 70-80 weight % (wt %) or volume % (v %) (selected from, for example, polypropylene (PP), polyethylene (PE), polyvinylidene fluoride (PVDF), nylon (Pa), polyester (PET), polytetrafluoroethylene (PTFE), polyphenylene sulfide (PPS), or a combination thereof).
Colour Masterbatch: 2-5 wt % or v %
Flame retardant additive: 10-30 wt % or v % (for example aromatic bromine active ingredients).
Foaming or blowing agent: 5 wt % or v % (for example, a compound of azodicarbonamide in a ethylene carrier).

In the specification, the term “colour masterbatch” should be understood to mean a solid additive (usually a granule) used for colouring plastic or polymers. The colour masterbatch typically consists of one or more colourants and a polymer-specific carrier resin. A colour masterbatch may contain up to 60% colourant. In the subsequent production process, the colourant is introduced into the melted plastic.

In the specification, the term “flame retardant additive” or “flame retardant” should be understood to mean a diverse group of chemicals that are added to manufactured materials, such as plastics and textiles, and surface finishes and coatings. Flame retardants are activated by the presence of an ignition source and are intended to prevent or slow the further development of ignition by a variety of different physical and chemical methods. They may be added as a copolymer during the polymerisation process, or later added to the polymer at a moulding or extrusion process or (particularly for textiles) applied as a topical finish. Examples of flame retardants include minerals (for example, aluminium hydroxide (ATH), magnesium hydroxide (MDH), huntite and hydromagnesite, various hydrates, red phosphorus, and boron compounds, mostly borates); organohalogen compounds (such as organochlorines (chlorendic acid derivatives and chlorinated paraffins); organobromines (decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD)); organophosphorus compounds (for example, organophosphates such as triphenyl phosphate (TPP), resorcinol bis(diphenylphosphate) (RDP), bisphenol A diphenyl phosphate (BADP), and tricresyl phosphate (TCP)); phosphonates (for example, dimethyl methylphosphonate (DMMP); and phosphinates such as aluminium diethyl phosphinate); compounds containing both phosphorus and a halogen (for example, tris(2,3-dibromopropyl) phosphate (brominated tris) and chlorinated organophosphates such as tris(1,3-dichloro-2-propyl)phosphate (chlorinated tris or TDCPP) and tetrakis(2-chlorethyl)dichloroisopentyldiphosphate (V6)); and organic compounds (for example, carboxylic acid and dicarboxylic acid). Mineral flame retardants are typically additive while organohalogen and organophosphorus compounds can be either reactive or additive.

In the specification, the term “foaming agent” should be understood to mean a material such as a surfactant or a blowing agent that facilitates the formation of foam. A surfactant (for example, sodium laureth sulfate, sodium lauryl ether sulfate (SLES), sodium lauryl sulfate (also known as sodium dodecyl sulfate or SDS), ammonium lauryl sulfate (ALS), and cocamide foaming agents (such as cocamide DEA, cocamidopropylamine oxide, cocamidopropyl betaine, and cocamidopropyl hydroxysultaine)), when present in small amounts, reduces surface tension of a liquid (reduces the work needed to create the foam) or increases its colloidal stability by inhibiting coalescence of bubbles. A blowing agent is a gas that forms the gaseous part of the foam (for example, carbon dioxide, pentane, chlorofluorocarbons) or can be an agent that produce gas via chemical reactions (for example, baking powder, azodicarbonamide, titanium hydride, and isocyanates).

In the specification, the term “mesh number” should be understood to mean the number of openings in one linear inch of screen or article of the claimed invention. For example, a 4-mesh screen has four openings across one inch of screen, while a 100-mesh screen has one hundred openings across one inch of screen.

In the specification, the term “body member” or “upstand”, which can be used interchangeably, should be understood to mean an upright structure or a turned-up edge of a flat surface.

In the specification, the term “snap(s)” should be understood to mean, as per the industry standard (“The First Snap-Fit Handbook”, 1st Edition, (P. Bonenberger) (2000)) a mechanical joint system where part-to-part attachment is accomplished with locating and locking features (constraint features) that are homogenous with one or the other of the components being joined. Joining requires the (flexible) locking features to move aside for engagement with the mating part, followed by return of the locking feature toward its original position to accomplish the interference required to latch the components together. Locator features, the second type of constraint feature, are inflexible, providing strength and stability in the attachment. Enhancements complete the snap-fit system, adding robustness and user-friendliness to the attachment. The commonest form of snaps are annular (circular connectors), cantilever (hook and recess), and torsional (a latch is attached to a torsion bar or shaft). Snap fits are commonly used as an assembly method for injection molded parts. The snaps are molded into the product, so additional parts are not needed to join them together. Additionally, if designed correctly, they can be disassembled and reassembled several times without any problems. A snap fit can either be designed as a permanent snap or a multiple snap. Permanent fits are used in disposable parts that are never meant to be disassembled. Multiple snaps are used in most designs where disassembly for service is expected.

In one embodiment of the present invention, the circular outer lip may further comprise a series of concentric reinforcement circular members radiating out and away from the open end.

Some of the technical problems solved by the claimed invention are the ability of a user to install the claimed penetration opening sealing cover or article faster in situ when compared to current methods; the claimed penetration opening sealing cover or article has a robust catchment mesh as standard, which is a significant safety feature as it stops any objects falling through the claimed penetration opening sealing cover or article onto the floor below which is populated with human activity; the claimed penetration opening sealing cover or article can be configurated to allow for spill or non-spill control applications; and the claimed invention incorporates a cross-member (strut channel) which can be used to secure services easily and safely between floors. The two piece nature of one embodiment of the claimed penetration opening sealing cover or article can incorporate insert 20 to create a fully sealed cover.

### BRIEF DESCRIPTION OF THE DRAWINGS

The invention will be more clearly understood from the following description of an embodiment thereof, given by way of example only, with reference to the accompanying drawings, in which:—

FIG. 1 illustrates perspective views (A) and (B), a side view (C), and a plan view (D) of one embodiment of the penetration opening sealing cover of the claimed invention.

FIG. 2 illustrates perspective views (A) and (B), a side view (C), and a plan view (D) of one embodiment of the penetration opening sealing cover of the claimed invention.

FIG. 3 illustrates a perspective view (A), a view of the underside (B) of the view (A), a perspective view (C) of the penetration opening sealing cover shown in views (A) and (B) joining together, and a perspective view (D) of one embodiment of the penetration opening sealing cover of the claimed invention.

FIG. 4 illustrates a perspective view (A), a side view (B), and a plan view (C) of one embodiment of the penetration opening sealing cover of the claimed invention.

FIG. 5 illustrates (A) a perspective view and (B) a plan view of a sub-assembly comprising a strut channel which is adapted for use with any one of the embodiments of the penetration opening sealing cover of the claimed invention illustrated in FIGS. 1 to 4.

### DETAILED DESCRIPTION OF THE DRAWINGS

### Materials and Methods

Injection moulding grade High Density Polyethylene or any of the materials listed above. These raw materials are blended accurately together using a combination of volumetric and gravitactic blender systems mounted above the throat of the injection moulding machine on a contained unit. The blending systems is designed to efficiently mix both polymer granules and additive powders in an accurate and precise process utilising a specialised auger. If the polymer material been used are of hydroscopic nature, they will have to be dried to the required moisture content before mixing can commence. The blended batch is then feed into the throat of the injection unit of the machine in a controlled manner through the drop bowl system under the blender.
A colour master batch or any other colour masterbatch is added in a colour of the customer requirements.
Flame retardant additives are added at a level to achieve the desired flame retardant requirements.
Chemical Blowing agent is typically used if a complex product design is required.
Processing and tooling methods are performed using known methods in the art.
Injection moulding process is used to manufacture the parts.
A range of interchangeable tooling inserts allows for the manufacture of slightly different product designs all in a single mould base system, making it a commercially efficient methos of manufacture.

### Discussion

The present invention provides a penetration opening sealing cover that acts as a catchment mesh or a cover in cleanroom facilities, which is a significant safety feature preventing objects and liquids falling through an opening in the floor and down to the floor below, whilst also offering a versatile sub assembly unit for service attachment.

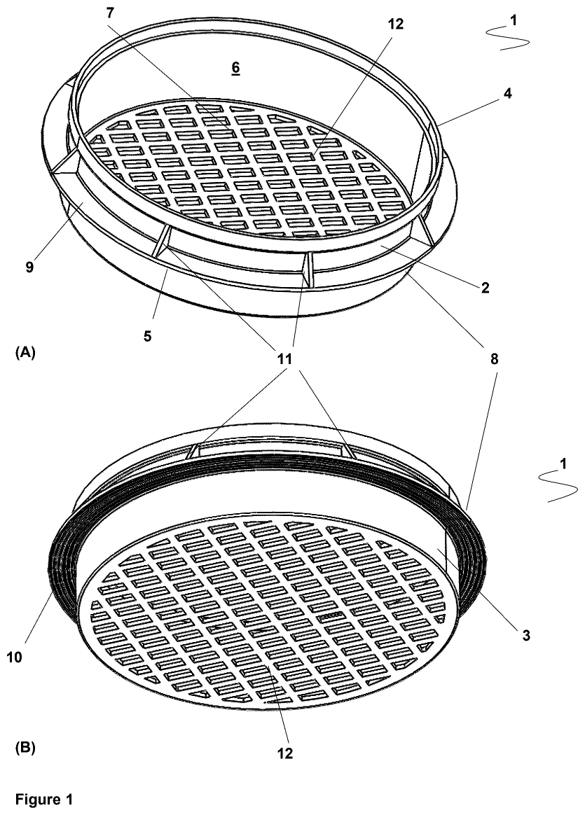

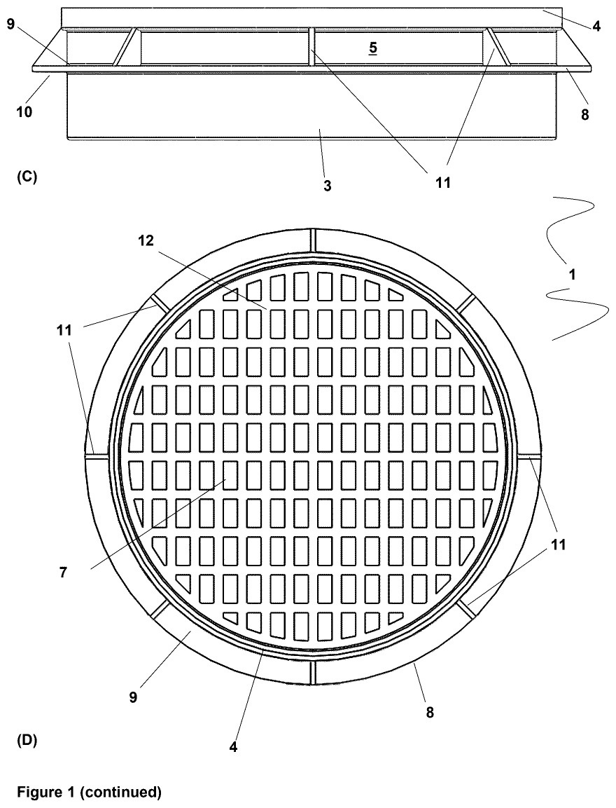

Referring now to the figures, where FIG. 1 illustrates a general embodiment of a penetration opening sealing cover of the present invention. The penetration opening sealing cover or article is illustrated in a circular shape in the drawings, however, the penetration opening sealing cover can be any shape that is required. Specifically, FIG. 1(A) illustrates a perspective view of a penetration opening sealing cover of the present invention, and is generally referred to by reference numeral 1. The penetration opening sealing cover 1 of the illustrated embodiment comprises a body member or the upstand 2 having a first side 3 and a second side 4 (shown in FIGS. 1(B) and (C)). The upstand 2 further comprises an outer wall 5 and an inner wall 6. The inner wall 6 of the upstand 2 defines a central cavity 7 within which an insert 20 can be accommodated. The penetration opening sealing cover 1 further comprise an outer lip 8 that is attached to, and follows the perimeter of the outer wall 5 of the upstand 2. The outer lip 8 is located (midway) between the first side 3 and the second side 4. The outer lip 8 follows the outline of the outer wall 5 of the penetration opening sealing cover 1, and comprises a top side 9 and a bottom side 10, and at least one rib 11 attached to the top side 9 of the outer lip 8 and the outer wall 5 of the upstand 2. The at least one rib 11 provides added structural rigidity to the penetration opening sealing cover 1. The bottom side 10 is adapted to accommodate a sealant and/or adhesive applied to the penetration opening sealing cover 1 during installation. When the penetration opening sealing cover 1 is placed into its position in a floor opening, the outer lip 8 creates the seal or bond with the floor. The bottom side 10 can have pre-applied adhesive tape applied to the underside of its surface. This allows for an alternative sealing method. A liner is removed from the adhesive tape on site and the penetration opening sealing cover 1 is placed into its position in a floor opening or wall opening, creating a water tight seal.

The upstand 2 ensures that no spillage of liquid can pass through the penetration opening sealing cover 1.

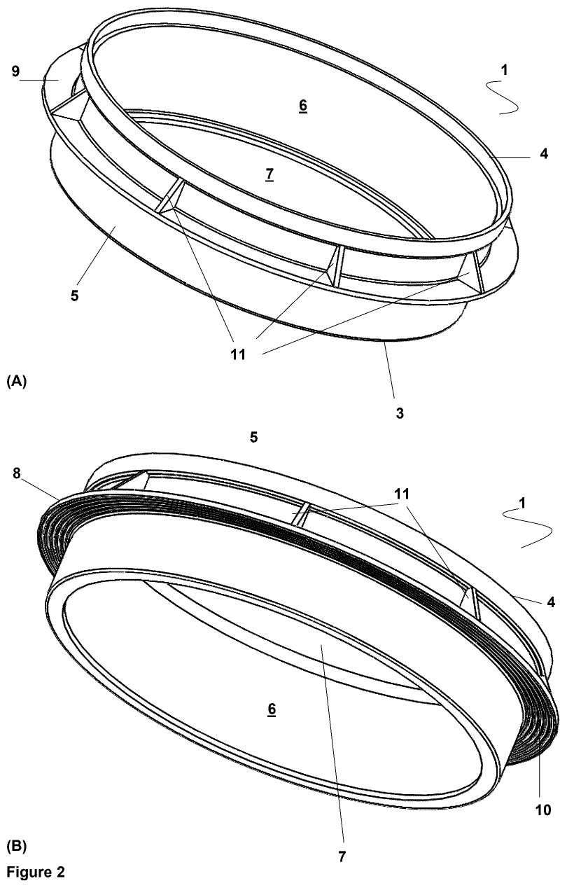

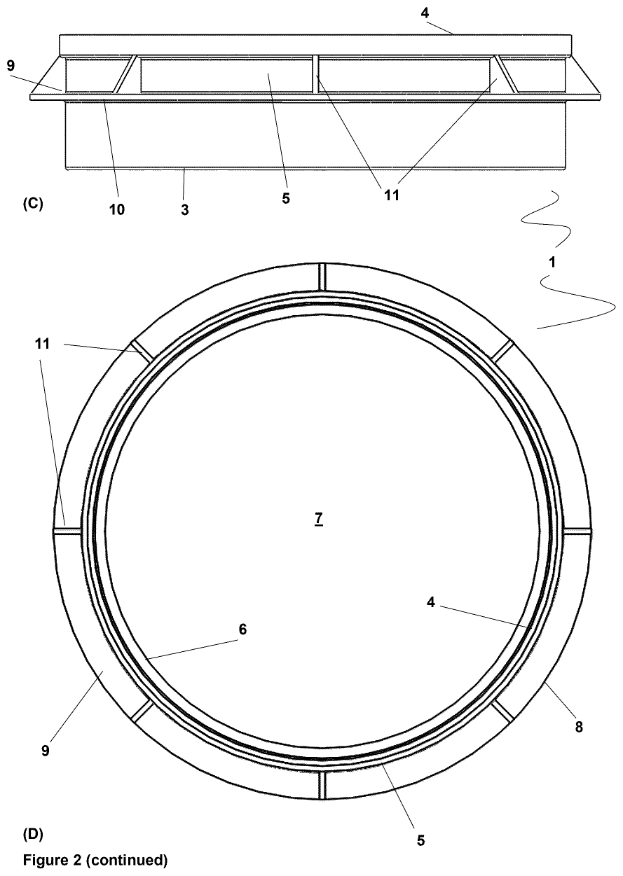

The second side 4 of the upstand 2 further comprises a lattice structure 12 that spans the central cavity 7 (see FIGS. 1(A), (B) and (D)). The lattice structure 12 comprises a regular series of strips of polymer crossed and fastened together with square or diamond-shaped spaces left between. The shapes of the lattice structure 12 are designed such that it achieves a certain element of free surface area which does not restrict air flow passing through article 1 when in position. This configuration can be altered to suit certain flow through conditions upon request. The thickness (for example, from 2 mm to 12 mm, such as 2 mm, 2.5 mm, 3 mm, 3.5 mm, 4 mm, 4.5 mm, 5 mm, 5.5 mm, 6 mm 7 mm, 7.5 mm, 8 mm, 8.5 mm, 9 mm, 9.5 mm, 10 mm, 10.5 mm, 11 mm, 11.5 mm, and 12 mm) of the lattice is designed to withstand dropped loads from a height (for example, it can withstand taking a 16 kg load dropped from a height of 600 mm), whilst also making it possible to be cut with hand tools for service install. The components of the penetration opening sealing cover 1 are typically made from the same material and the penetration opening sealing cover 1 is typically made as a single piece. FIG. 2(A)-(D) illustrate the penetration opening sealing cover 1 as shown in FIG. 1 without any lattice structure 12 across the cavity 7. In this embodiment, the lattice 12 is removed to accommodate large singular diameter service ducts.

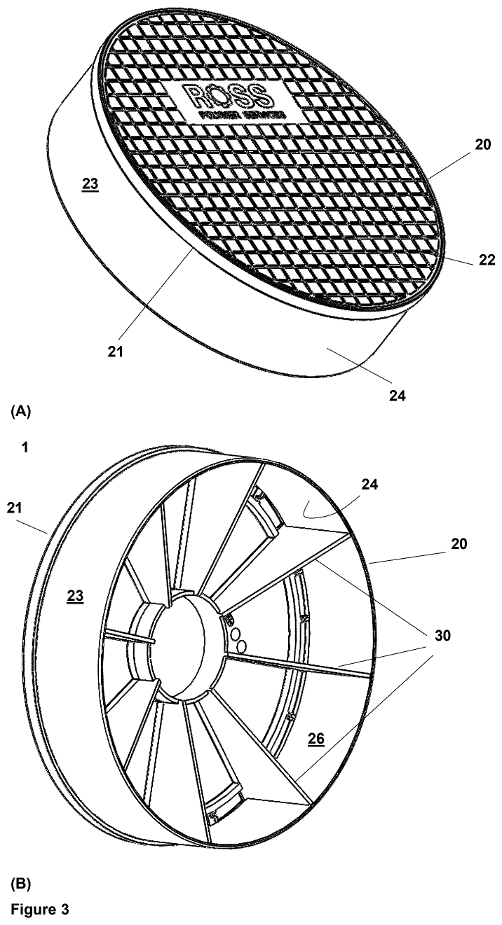

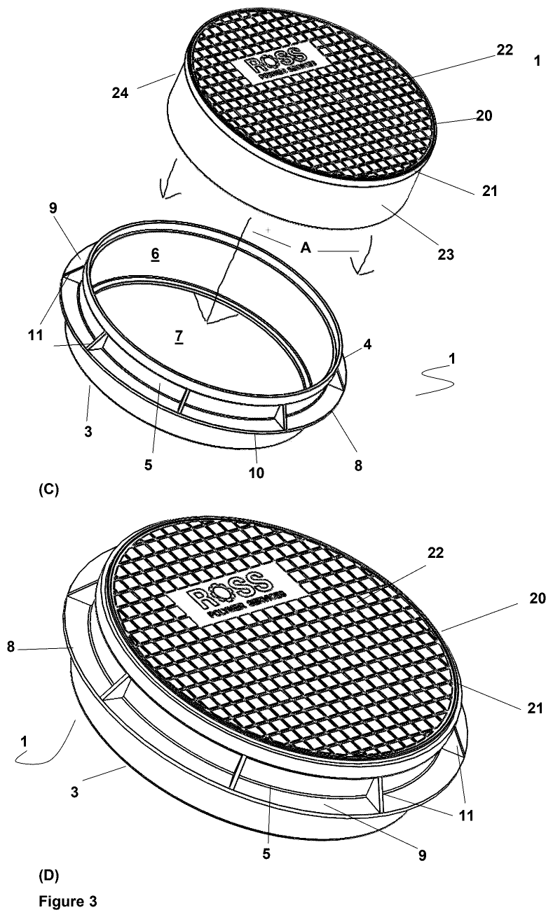

Turning now to FIG. 3(A) there is illustrated the insert 20, which comprises a top surface 21 having a lattice structure 22, and a wall 24 extending from the top surface 21. The wall 24 comprises an external surface 23 and an internal surface 26 (see FIG. 3(B)). The internal surface 26 of the wall 24 creates a space 28 within which is located a series of ribs 30 attached to, and extending inward from, the internal surface 26 of the wall 24 such that they converge towards one another. Although the penetration opening sealing cover 1 is meant to be used as a non-load bearing article, the inclusion of the series of ribs 30 achieve a higher level of structural rigidity. The insert 20 can be inserted into the cavity 7 of the penetration opening sealing cover 1 (see FIG. 3(C)), forming a tight fit (see FIG. 3(D)). The insert 20 can be further secured to the penetration opening sealing cover 1 by the use of a sealant, adhesive or other fixative to ensure that no liquids can spill into the floor below. The sealant, adhesive or fixative can be pre-applied to, for example, the external surface 23 of the wall 24 or under the top surface 21 in the same manner as that for the bottom side 10 as described above.

The penetration opening sealing cover 1, together with the insert 20, shown in FIGS. 1 to 3 can be used to prevent spills which may occur on the floor in a cleanroom, a wet room, a data centre, or a hospital setting from falling into an adjacent room or down to a floor below by one easy assembly step compared to multiple steps as per current POR. The lattice structure 22 can be either patterned or smooth depending on the customer's requirements.

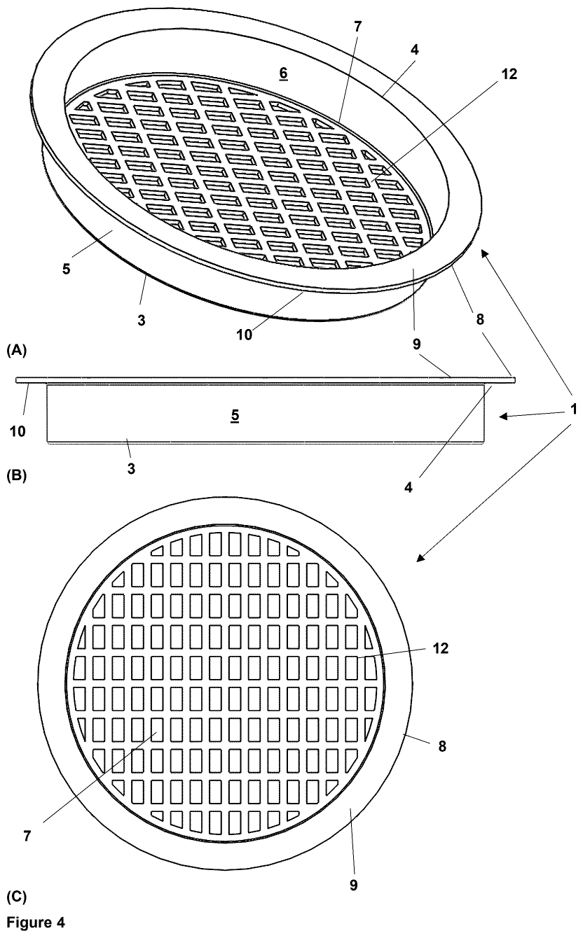

As illustrated in FIG. 4(A), there is presented a perspective view of the penetration opening sealing cover 1 of FIG. 1 where the outer lip 8 is situated at the first side 3, distal the lattice structure 12, such that the top side 9 of the outer lip 8 creates the lip. The penetration opening sealing cover 1 shown in FIG. 4 can be used in, for example, a cleanroom where no liquid spillage occurs.

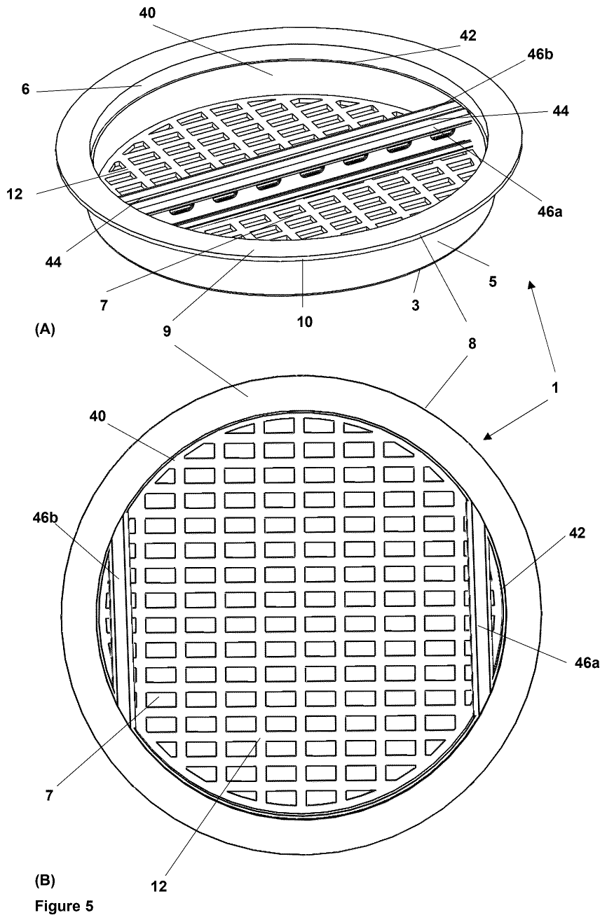

FIG. 5 shows the penetration opening sealing cover 1 of FIG. 4(A) with a sub-assembly 40 inserted into the central cavity 7 and resting on the lattice structure 12. The sub-assembly 40 comprises a support structure 42 adapted to moveably support a strut channel 44. The strut channel 44 comprises a pair of moveable struts 46a, b (a one piece, slotted back-to-back unistrut part) that traverse the diameter of the central cavity 7 and which move in opposite directions to each other along the inner wall 6 of the upstand 2. The sub-assembly 40 allows the direction of the strut channel 44 to move relative to the shape of the article to suit the attachment of service during install. For example, if the penetration opening sealing cover 1 is circular in shape, the sub-assembly 40 will be able to rotate 360° to accommodate services. The sub-assembly 40 is designed to fit into the central cavity 7 of any embodiment of the penetration opening sealing cover 1 and allows for the attachment of services to be secured to the penetration opening sealing cover 1 with ease during a tool install phase during construction of, for example, a cleanroom. The sub-assembly 40 is typically manufactured from mild steel, plain carbon steel, galvanised steel, stainless steel, or a zinc dichromate coated of any of the above-mentioned metals. There is also a perimeter cross strut option which makes this product even more versatile as shown in FIGS. 5A and 5B. This slotted cross strut is available on both sides giving greater versatility for service install.

The claimed penetration opening sealing cover 1 is a multifunctional design all combined in one simple, light weight and easy to install product. Non-toxic, zero off gassing materials are used in its manufacture, and the claimed penetration opening sealing cover 1 is suitable for use in areas of highly controlled environment applications. A seamless outer lip 8 is an option where liquid spillages are a possibility. The one-piece design of the claimed penetration opening sealing cover 1 is used to completely seal off floor cut outs in minutes, without the need for several different materials, specialised equipment, or separate groups of specialised teams to install the claimed penetration opening sealing cover 1. The claimed penetration opening sealing cover 1 also has the advantage of incorporating a sub-assembly 40 which can be used to secure services easily and safely from floor-to-floor. The penetration opening sealing cover 1 of the claimed invention can also comprise a series of ribs 30 which aid in accommodating the support feature 42 without the need for the sub-assembly 40.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiments hereinbefore described but may be varied in both construction and detail.

1. A penetration opening sealing cover (1) comprising an upstand (2) having a first side (3) and a second side (4); an outer wall (5) and an inner wall (6) connecting the first side (3) and the second side (4), wherein the inner wall (6) defines a central cavity (7); and an outer lip (8) comprising a top side (9) and a bottom side (10), wherein the upstand (2) is configured to prevent a spillage from passing through the penetration opening sealing cover (1), and wherein the first side (3) further comprises a lattice structure (12) that spans the width of the central cavity (7).

2. The penetration opening sealing cover (1) of claim 1, wherein the outer lip (8) is attached to, and follows the perimeter of, the outer wall (5) of the upstand (2).

3. The penetration opening sealing cover (1) of laim 12, wherein the outer lip (8) is located between the first side (3) and the second side (4) of the penetration opening sealing cover (1), and further comprises at least one buttress (11) attached to the top side (9) of the outer lip (8) and the outer wall (5) of the upstand (2).

4. The penetration opening sealing cover (1) of claim 1, wherein the outer lip (8) is situated at the first side (3) and forms a lip around the perimeter of the penetration opening sealing cover (1).

5. The penetration opening sealing cover (1) of claim 1, wherein the lattice structure (12) comprises a regular series of strips of polymer crossed and fastened together with shaped spaces left between.

6. The penetration opening sealing cover (1) according to claim 5, wherein the series of strips of polymer of the lattice structure each have a thickness of between about 2 mm and about 12 mm.

7. The penetration opening sealing cover (1) of claim 1, wherein the central cavity (7) is open from the second side (4) and through the first side (3).

8. The penetration opening sealing cover (1) of claim 1, wherein the first side (4) is closed.

9. A penetration opening sealing cover (1) comprising an upstand (2) having a first side (3) and a second side (4); an outer wall (5) and an inner wall (6) connecting the first side (3) and the second side (4), wherein the inner wall (6) defines a central cavity (7); and an outer lip (8) comprising a top side (9) and a bottom side (10), wherein the upstand (2) is configured to prevent a spillage from passing through the penetration opening sealing cover (1).

10. (canceled)

11. (canceled)

12. (canceled)

13. (canceled)

14. (canceled)

15. (canceled)

16. The penetration opening sealing cover (1) according to claim 9, further comprising an insert (20).

17. The penetration opening sealing cover (1) according to claim 16, wherein the insert (20) comprises a top surface (21) having a lattice structure (22), and a wall (24) extending from the top surface (21).

18. The penetration opening sealing cover (1) according to claim 17, wherein the wall (24) comprises an external surface (23) and an internal surface (26).

19. The penetration opening sealing cover (1) according to claim 18, wherein the internal surface (26) of the wall (24) creates a space (28) within which is located a series of (30) attached to, and extending inward from, the internal surface (26) of the wall (24) such that they converge towards one another.

20. The penetration opening sealing cover (1) according to claim 16, wherein the insert (20) is configured to fit within the dimensions of the bore (7) of the penetration opening sealing cover (1).

21. The penetration opening sealing cover (1) according to claim 9, further comprising a sub-assembly (40), the sub-assembly (40) comprising a support structure (42) adapted to moveably support a strut channel (44).

22. The penetration opening sealing cover (1) according to claim 21, wherein the strut channel (44) comprises a pair of moveable struts (46a, b) that traverse the diameter of the bore (7) and which move in opposite directions to each other along the inner wall (6) of the upstand (2).

23. The penetration opening sealing cover (1) of claim 21, wherein the sub-assembly (40) is configured to sit in the bore (7) of the penetration opening sealing cover (1)

24. The penetration opening sealing cover (1) of claim 21, wherein the sub-assembly (40) is composed of a metal selected from mild steel, plain carbon steel, galvanised steel, stainless steel, or a zinc dichromate coating thereof.

25. The penetration opening sealing cover (1) according to claim 9, wherein the penetration opening sealing cover (1) is composed of a polymer selected from polypropylene, polyethylene, polytetrafluoroethylene, nylon, polyester, or a combination thereof.

26. The penetration opening sealing cover (1) according to claim 9, wherein the penetration opening sealing cover (1) is comprised of a single piece.
